(19) United States
(12) Patent Application Publication
(10) Pub. No.: US 2008/0046819 A1
(43) Pub. Date: Feb. 21, 2008

(54) ANIMATION METHOD AND APPRATUS FOR EDUCATIONAL PLAY

(76) Inventors: Michael D. DeCamp, Sunrise, FL (US); Kenneth Lam Hau Ming, Tsuen Wan (HK)

Correspondence Address: LACKENBACH SIEGEL, LLP, LACKENBACH SIEGEL BUILDING, 1 CHASE ROAD, SCARSDALE, NY, 10583, US

(21) Appl. No.: 11/462,450

(22) Filed: Aug. 4, 2006

(51) Int. Cl. G06F 3/041

(52) U.S. Cl. 715/706; 345/473; 345/173; 345/174

(57) ABSTRACT

A play-oriented workstation is disclosed that has a worktable where an articulatable 2-D or 3-D character is placed among scenery items, an angularly displaceable positioning arm attached to the worktable, a digital camera pivotably attached to the positioning arm and streamlined control key functions that provide creative flexibility and functional transparency. The workstation selectably displays either a real-time video feed from the digital camera in the capture mode on a video screen or else, in the display mode, a stored image that is designated as the current image in response to actuation of a mode key. Pressing a capture/confirm key in the capture mode, captures and stores an image from the video feed as a current image in memory, and re-positioning the articulatable character each time the capture/confirm key is pressed stores images that can subsequently be retrieved as a temporal sequence of stored images as a movie in display mode. Pressing the play key in display mode alternately displays the stored sequence of stored images as a movie and pauses the movie at a new current image and pressing or holding left and right arrow keys changes the current image displayed by the video screen. Alternatively, after the delete key is pressed the arrow keys select whether one or more images will be deleted and the capture/confirm key enables the action selected by the delete key. Image sequences can be exported by the controller from working memory to portable storage such as SD/MMC cards. Sound effects and voice-overs can be imported from pre-recorded SD/MMC cards or recorded and exported to an SD/MMC card for archival storage and sound effect selector keys are provided for selecting individual sound effects.

### BACKGROUND OF THE INVENTION

The present invention relates to the production of animation sequences. More particularly, the present invention is directed to enabling children to produce animation sequences in the course of creative play.

Many young people, even those whose are affected by learning disabilities and autism, are fascinated by the fantasy narratives of Marvel Comics™ and the Harry Potter™ books. However, an important aspect of education is teaching children to create coherent, sustained narratives of their own, rather than merely being passive consumers of others' creative output.

In school, this is done most often in story-writing exercises that require each student to build a useful vocabulary in a particular language, one that may be foreign to them. Then, in a further step, they must apply that language's rules of grammar and spelling to those vocabulary words in order to record their own invented narrative sequence.

For any children who are struggling with the vocabulary and rules of a language because they are not yet fluent in it, these assignments are hard work. In such cases the result is likely to be awkward, unpersuasive, even incoherent, and a source of anxiety and embarrassment for the child, not fun.

Also, many children who are affected by learning disabilities and autism, even some who have good reading skills, are more fluent in expressing themselves using images, rather than words. These children may also find such story-writing exercises difficult and unappealing.

A teacher may provide story boards to help children develop orderly, sequential narratives, but that is a very static format for a fantasy adventure tale. Moreover, the assignment then becomes just another grammar and spelling exercise—not even a creative writing assignment, much less creative play.

Animation, although historically a very labor intensive art form, now employs expensive high-end, high-tech computers and cutting-edge automation software to eliminate the manual generation of the image frames in animation sequences and to enable animators to generate complex video special effects. In contrast, play-oriented animation apparatus must be inexpensive and encourage manipulation of the physical elements of a scene. In particular, as a play-oriented device, it must be flexible enough to not unduly limit creative storytelling options but also reliable and user-friendly enough to be substantially transparent to the user, so that the children can enjoy the visual narrative that they are creating without the disappointment caused by unintended results.

### SUMMARY OF THE INVENTION

In accordance with the present invention, an animation station is provided that stores images in a memory and provides a temporal sequence of the stored images to a display screen as a movie. The animation station has a positioning arm attached to a worktable. A camera adapted to provide an image signal to a display screen is adapted to be attached to the positioning arm so that the image signal provides an image on the display screen that shows an object located on the worktable.

The animation station includes a first key adapted to selectably provide a first mode in which the image signal from the camera is provided to the display screen and a second mode wherein a current image is provided to the display screen from an image stored in the memory; a second key adapted to change the current image provided to the display screen from an image stored in the memory from a first current image provided to the display screen from the image stored in the memory to a second current image provided to the display screen from another image stored in the memory; and a third key adapted to delete from the memory the image stored in the memory that provides the current image to the display screen and a fourth key adapted to store an image captured from said image signal in memory.

Preferably the fourth key is adapted to store an image captured from the image signal in memory in the first mode and to enable deletion of the current image by the third key in the second mode.

Preferably the animation station is in the first mode each time power is applied to the animation station.

Preferably the third key is adapted to delete the temporal sequence from the memory when the third key is actuated twice before the fourth key is actuated.

Preferably the positioning arm is angularly displaceable relative to the worktable and the camera is pivotably attached to the positioning arm.

Preferably the camera is rotatably attached to the positioning arm, so that rotating the camera rotates the image provided by the image signal to the display screen.

In a particular embodiment the animation station includes a plurality of sound effects switches, each sound effects switch generating a respective sound effect when the switch is actuated.

A particular embodiment of the animation station includes sound recording means adapted to provide recorded sound for the stored temporal sequence.

In accordance with the invention an object is located on the worktable and the camera is positioned so that an image signal produced by the camera provides an image on the display screen that shows the object. A first key is actuated to selectably alternate between the first mode wherein the image signal from the camera is provided to the display screen and the second mode wherein a current image is provided to the display screen from an image stored in the memory. A second key is actuated to change the current image provided to the display screen from an image stored in the memory from a first current image provided to the display screen from the image stored in the memory to a second current image provided to the display screen from another image stored in the memory. A third key is actuated to selectably delete the image stored in the memory that provides the current image to the display screen from the memory and a fourth key is actuated to store an image captured from the image signal in memory.

Preferably actuating the fourth key stores an image captured from the image signal in memory if the animation station is in the first mode and actuating the fourth key enables deletion of the current image by the third key if the animation station is in the second mode.

Preferably actuating the third key a second time before the fourth key is actuated deletes the temporal sequence from the memory.

Preferably, actuating the fourth key again in the first mode captures a subsequent image from the image signal and stores the subsequent image in memory as the current image.

Actuating a fifth key displays the temporal sequence of the images stored in the memory on the video screen as a movie.

Preferably, actuating the fifth key again during the display of the temporal sequence of stored images as a movie pauses the movie display at a current image.

### BRIEF DESCRIPTION OF THE FIGURES

The present invention will be better understood when the detailed description of present invention is considered in conjunction with the figures provided wherein:

FIG. 1a is a perspective view of an embodiment of the invention used to capture an image of a background sheet overlaid with articulated 2-D characters;

FIG. 1b is a perspective view of a presently preferred, simplified embodiment of the invention;

FIG. 1c is a perspective view of the embodiment of FIG. 1b used to capture an image of a background sheet, scenery and an articulated 3-D character;

FIG. 2 is a schematic block diagram of a start up sequence for the presently preferred embodiment of the invention shown in FIG. 1;

FIG. 2a is a schematic block diagram of an image capture sequence for the presently preferred embodiment of the invention shown in FIG. 1;

FIG. 3 is a schematic block diagram of a playback sequence for the presently preferred embodiment of the invention shown in FIG. 1;

FIG. 4 is a schematic block diagram of scroll sequences for the presently preferred embodiment of the invention shown in FIG. 1;

FIG. 5 is a schematic block diagram of a delete sequence for the presently preferred embodiment of the invention shown in FIG. 1; and

FIG. 6 is a schematic block diagram of operations for the embodiment shown in FIG. 1.

In these drawings, similar structures are assigned similar reference numerals.

### DETAILED DESCRIPTION OF PRESENTLY PREFERRED EMBODIMENTS

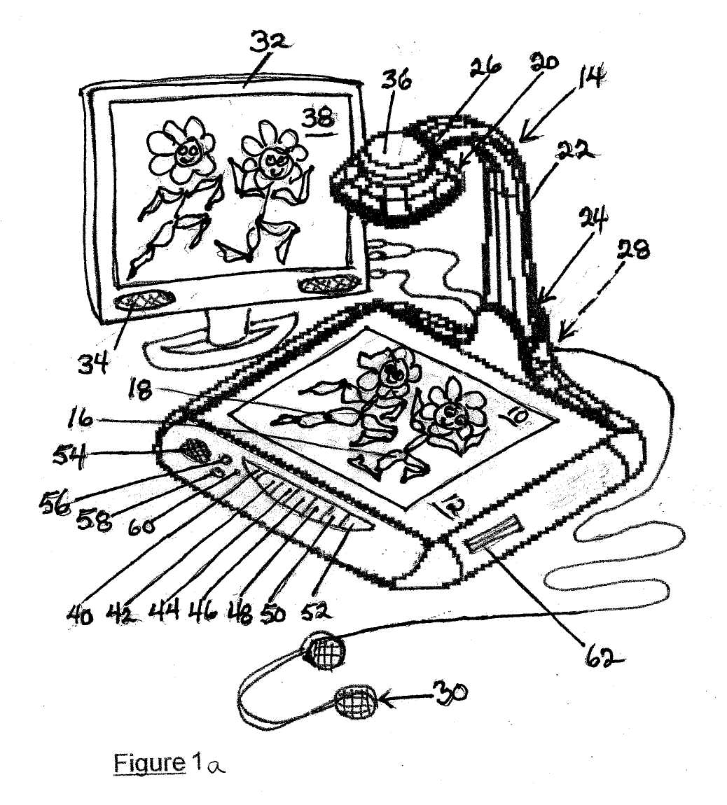

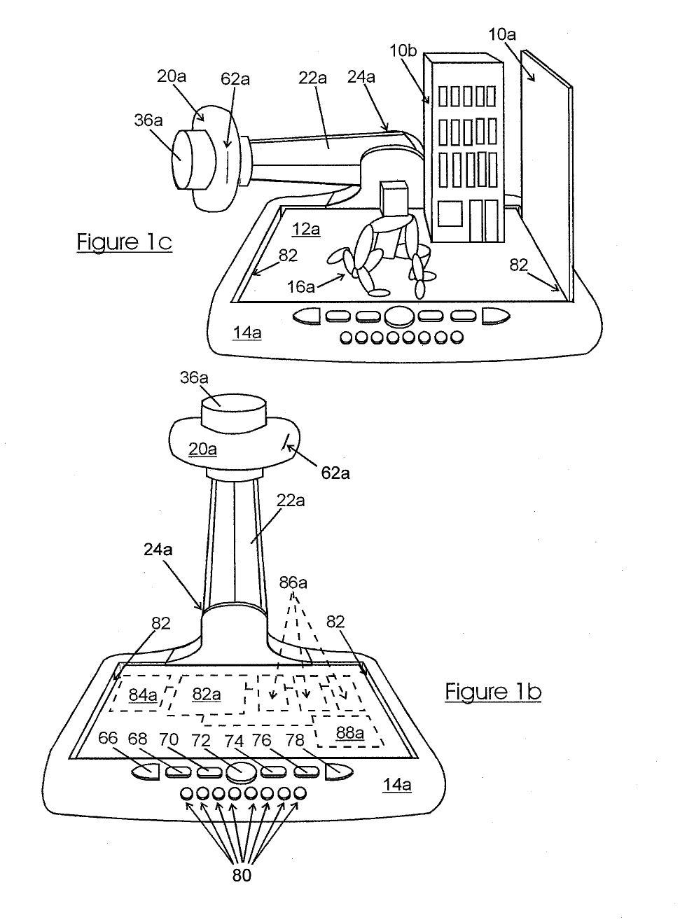

In FIG. 1a a background sheet 10 on the worktable 12 of an animation station 14 in accordance with a presently preferred embodiment of the invention, is overlaid with two articulated two-dimensional (2-D) characters 16 having hinged arm and leg joints 18. A rotatable turret 20 is supported by a positioning arm 22 that is attached to the worktable 12 by a hinge joint 24. The hinge joint 24 permits angular displacement of the positioning arm 22 to the left and the right. The turret 20 is also pivotable about a neck joint 26 on the positioning arm 22. A group of plug connectors 28 (not shown) provide audio and video outputs from the animation station 14 to headphones 30 and to a conventional VGA video monitor 32 having speakers 34.

As shown in FIG. 1c, the hinge joint 24 and neck joint 26 make it possible to move the camera 32 relative to the table 12 as needed when capturing a sequence images showing rubbery articulated three-dimensional (3-D) action characters 16a that are moved relative to each other and also relative to a 2-D scenery backboard 10a held in a respective gutter 82 on the worktable 12a and 3-D background elements 10b from the last captured image to the next image to be captured. Specifically, the positioning arm 22a is rotatable about the hinge joint 24a toward either the right or left edge of the table 12a and, when the positioning arm is angularly displaced the turret 20, 20a is rotated to maintain the horizon of the scenery, 10a in FIG. 1c, parallel to the lower edge of the screen when it is displayed. The neck joint 26 can also be pivoted to further adjust the field of view for the animation station 14 of FIG. 1a, which is not provided by the simpler embodiment 14a.

With reference to FIG. 1a, the digital camera 36 provides a real-time VGA video feed signal, that may be a continuous video stream or a repeatedly automatically updated still frame, that produces a display 38 on the video monitor 32. The video feed shows the scene elements that the operator is arranging on the worktable 12 in real time.

The image in each frame of an animation sequence recorded by the animation station 14 is an image captured from the camera's video feed 38 when the capture/confirm key 46 is pressed. The captured image is then stored in memory by the animation station 14 as a new “current frame”. Sequences of stored images captured in this way can also be output from the internal memory to a flash memory card inserted in the SD/MMC card slot 62 for archiving. A 32 MB SD or MMC formatted card can store 420 to 615 of these frames in standard JPEG format. MPEG or Audio-visual interleaved (AVI) image formats may be used instead.

User-friendly animation station control is provided by a plug-and-play audio-video controller 82 (not shown) located under the worktable 12 using seven Mini-tact™ switches that provide scroll back/left arrow 40, delete 42, play 44, capture/confirm 46, mode 48, on/off 50 and scroll forward/right arrow 52 control-function keys. A microphone 54, audio record 56 and audio playback switches 58, and an audio recording pilot light, are provided to the left of the control switches 40 to 52 for adding user-recorded voice-over and sound effects content. Pre-recorded sound effects can be added to an animation sequence from memory cards inserted in the SD/MMC card slot 62. Sound effects and dialog are also stored on such cards for future use. Alternatively, individual pre-recorded sound effects can be selected by the operator from pre-recorded sound effects stored on a ROM chip 84 (not shown) located under the worktable 12, using optional controls provided by on-screen display (OSD) text, described below. The animation station 14 has 8 MB of RAM working memory 86 (not shown) that can store from 76 to 100 VGA frames at 640×480 resolution, in addition to ROM program storage 88 (not shown).

A presently preferred, simplified embodiment of the animation station 14a shown in FIG. 1b and 1c also has the same array of seven control switches 40-52, supplemented by the sound effect selector switches 80. Again a group of plug connectors 28a (not shown) provide audio and video outputs for connecting the animation station 14a to a video monitor, speakers and headphones (not shown). The plug-and-play audio-video controller 82a, ROM sound effects chip 84a, 8MB of working memory 86a and ROM program storage 88a, located inside the animation station 14a under the work table 12a, are shown in phantom.

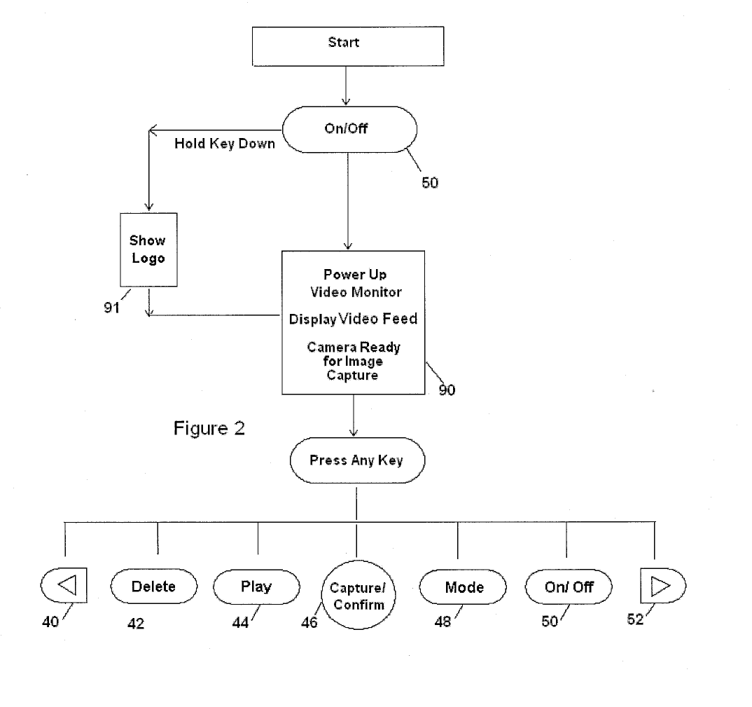

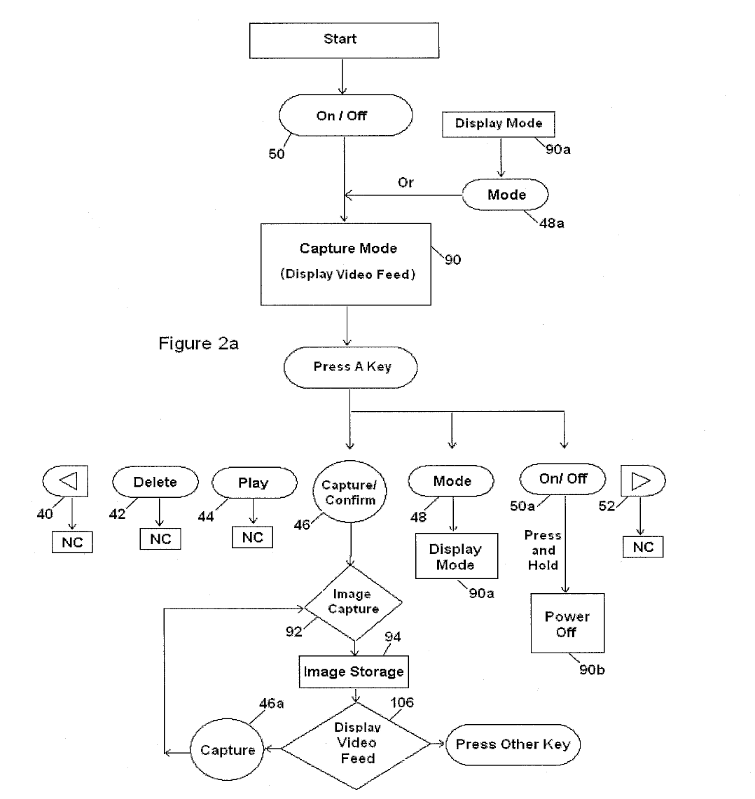

With reference to FIG. 2, pressing the on/off key 50 to turn on these animation stations produces a live video feed 38 from the camera 36 that is displayed on the monitor 32, so that the operator can adjust the scene and the point of view and view angle that is shown on the video screen before capturing it as an image for an animation sequence. This real-time feedback is preferably provided by full-motion video rather than continuously updated still frames, and is particularly important to encouraging manipulation of the camera and the scene by the operator, particularly important to encouraging creative play.

When the live video feed 38 from the camera 36 is being sent to the monitor 32, the animation station 14, 14a, is operating in the “capture mode” 90. The camera is ready to capture images as soon as a “camera ready” icon appears on the screen in the capture mode. Pressing and holding the on/off key 50 when turning on the animation station displays a stored marquee image 91 that includes the manufacturer's logo, as long as the on/off key is held down, as shown in FIG. 2. The video screen then displays the live video feed 38 when the on/off key is released. However, after turning on 50 the animation station 14, pressing the on/off key again 50b shuts off power 90b to the animation station 14 if the on/off key 50 is held down for several enough. This prevents inadvertent loss of power, and possible loss of captured images.

Pressing the capture/confirm key 46 captures or “snaps” 92 an image frame from the real-time video feed 38 that is displayed by the video screen 32, as shown in FIG. 2a. The image is then automatically stored 94 as a current image that will be displayed on the video screen 32 if the mode key 48 is pressed to switch from the capture mode which shows the operator's hands arranging characters in a scene on the worktable, to the display mode 90a where images that have been captured are displayed either singly or as a movie. The captured image may be stored in working memory or on non-volatile removable memory media. However, the video screen continues to monitor the real-time video feed 106 of changes the operator is making in capture mode 90.

Pressing the capture/confirm key a second time 46a in capture mode 90 captures and stores a new current image that will be displayed by the video monitor in the display mode 90a if the mode key 48 is pressed, and so on. Pressing the on/off key again 50a powers down 94 the animation station 14. In the preferred embodiment shown in FIG. 1b and 1c, pressing the arrow keys 40, 52, or delete 42 and playback 44 keys, produces no response in capture mode, that is, there is “no connection” (NC), eliminating access to functions that use stored images that are not seen while the live video feed is displayed. On the other hand, in the embodiment of FIG. 1a, the arrow keys may be modified by changing program memory to reassign the arrow key 40, 52 for use with on-screen display (OSD) text. This OSD text permits ad hoc software programming of optional audio functions, etc., using the basic seven control keys 40-52. However key reassignment can preserve functional compatibility with the operating procedures of non-OSD embodiments for the sake of operational transparency of the OSD functions to the operator, as explained further below.

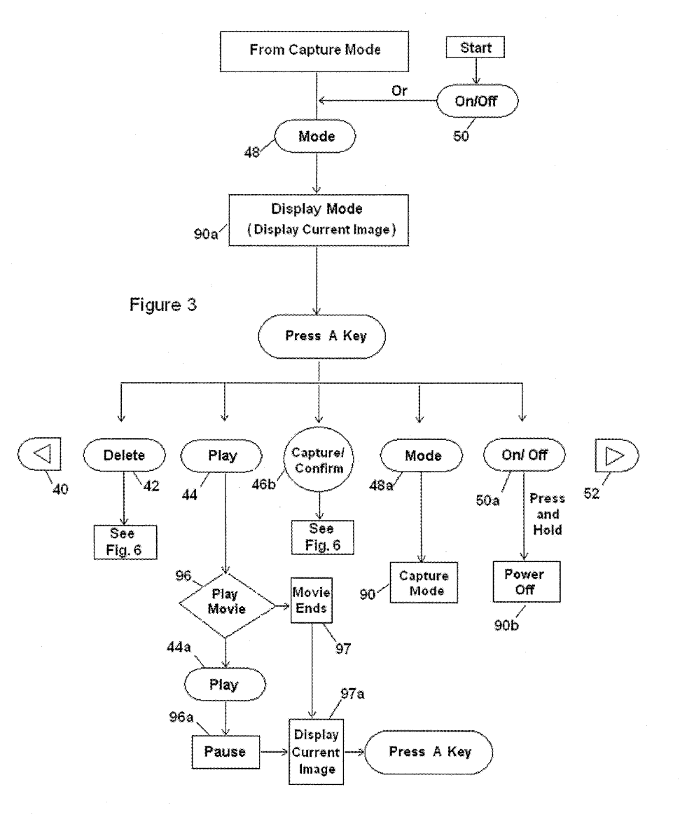

While in capture mode, pressing and holding the mode key 48 down for three seconds will switches the animation station 14 to display mode operation 90a, as shown in FIG. 3. In display mode 90a the stored current image 94 that was most recently snapped 92 by the animation station 14 while operating in the capture mode 90 is displayed first. When the mode key is pressed 48a while the animation station 14 is operating in the display mode 90a, the animation station 14 switches back to the capture mode 90 and displays the real-time video feed again 106, rather than the stored current image.

In capture mode, the display screen 32 displays the number of additional captured frames that can be stored by the station 14, 14a and its removable memory media, if any, in addition to the real-time video feed of the characters being arranged on the worktable. Also, a camera icon and memory card icon (not shown) indicate that the camera and removable memory are ready for use in the capture mode. In the display mode, a counter showing the sequence number of the stored current frame that is being displayed and total number of frames that have been stored. A warning icon for the low-battery condition is also provided in both modes (not shown) to guard against image loss.

With reference to FIG. 3, in the display mode 90a, pressing the play key 44, initiates a rapid display of the sequence of image frames that are stored in working memory at a rate of 8-10 fps as an animation movie, beginning with the current image that is being displayed and ending at the last image 97 in the stored sequence. These stored images have a predetermined sequence number, as noted above, but are not necessarily stored in sequential locations.

As shown in FIG. 3, pressing the play key 44a again before the end of the movie 97, pauses the movie 96a at the then the current image 97a. Pressing the play key 44 once again, continues playing the stored image sequence as an animated movie from the image on which the movie was paused 97a to the end of the movie 97, providing one-key control of the play function. However, the current image 97a displayed at the end of the movie is the stored image displayed when the play key 44 was pressed and the playback 96 of the stored sequence of images began, in FIG. 3 that would be the same image as the initial current image seen upon entry into the display mode 90a.

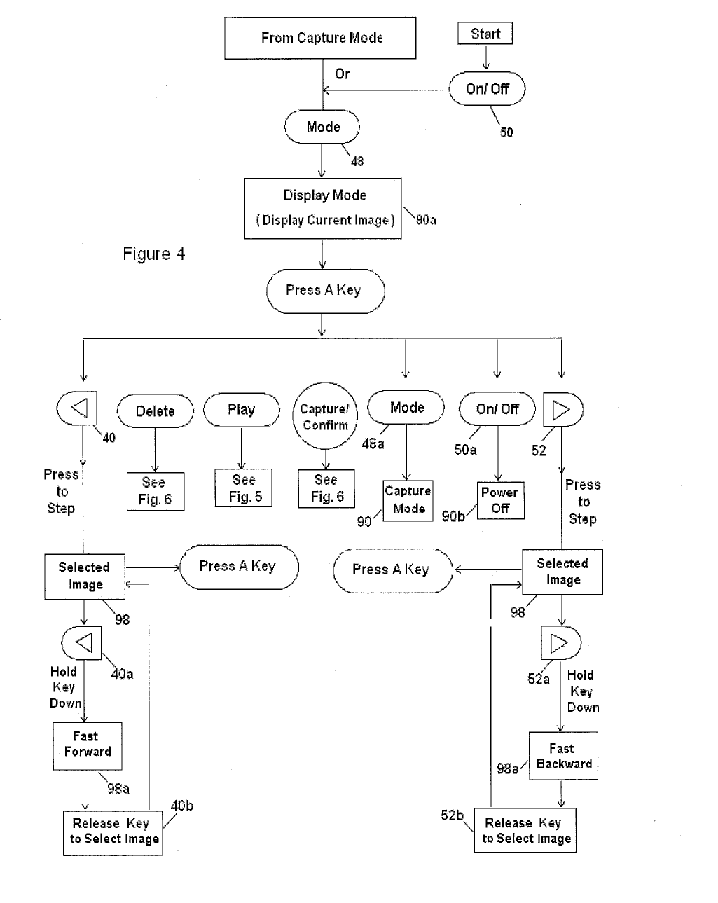

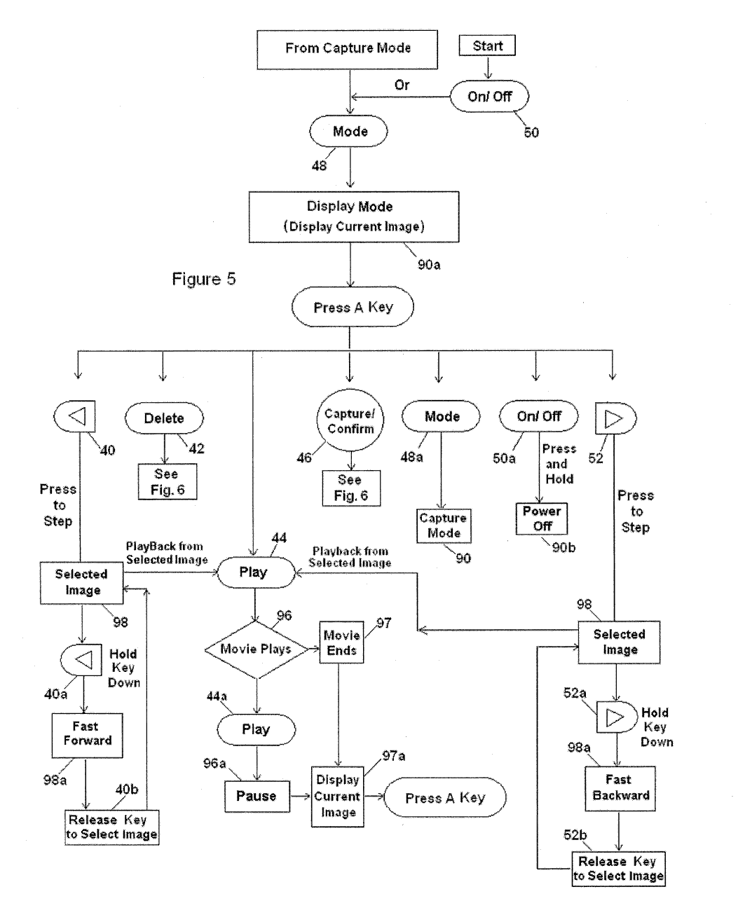

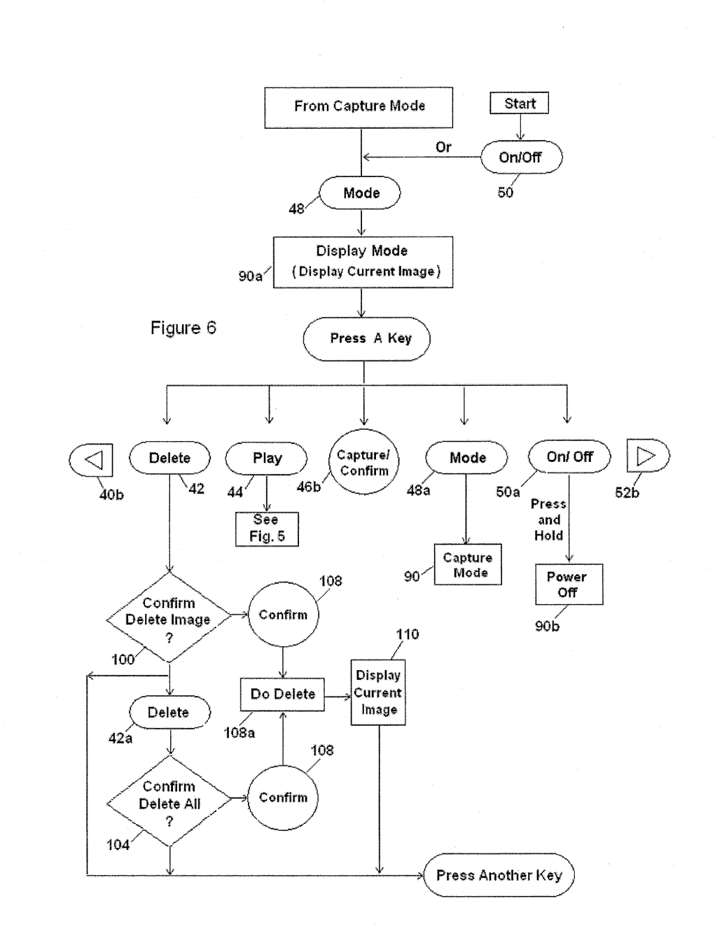

Any current image 97a that is displayed by the monitor 32 in the display mode 90a, can also be selectively changed to any other stored image 94 in the numbered sequence of stored images using the scroll/arrow keys 40, 52, as shown in FIGS. 4 and 5. In FIG. 4, briefly pressing either of the scroll keys 40, 52, steps the current image through the stored sequence of images by displaying each image as a newly-selected current image 98. However, if the scroll key 40, 52, is pressed and held 40a, 52a, the stored image that will be selected for display as the current image 98 is determined by how long the arrow key is held 40a, 52a, that is, the longer an arrow key 40a, 52a is held, the greater the number of images that are rapidly passed by 98a in the sequence of stored images before a next current image 98 is selected. Thus, the new selected current image 98 that appears after the respective arrow key is released 40b, 52b will be closer to the beginning (40a) or to the end (52a) of the stored image sequence, respectively, the longer the respective key is held down.

FIG. 5 shows that pressing the play key 44 after pressing the mode key 48 to display the current image plays the entire sequence of stored images as a movie, from beginning to end. However, the movie can also be played back beginning with any current image 98 that was selected 40b, 52b, in FIG. 4, as shown in FIG. 5.

In FIG. 2a, when the delete key 42 is pressed in capture mode there is no response, as noted above. However, in either embodiment 14, 14a, when the delete key 42 is pressed after the mode key 48 is pressed to enter the display mode, as shown in FIG. 5, and the capture/confirm key is then pressed 108, the capture/confirm key 46b enables deletion 108a of the current image displayed by the video screen by the delete key 42. The current image that was displayed on the video screen 32 is then deleted from memory 86, making the previous current image in the stored image sequence the new current image 110. However, if the delete key is pressed a second time before the capture/confirm key 46b is pressed 108 after the mode key 48 is pressed to enter the display mode, then the entire sequence of stored images including the current image will be deleted when the capture/confirm key 46b is pressed 108, leaving a blank current image on the display screen 32. If another key 40, 44, 48-52, that is not the delete key 42 or the capture/confirm key 46b is pressed, then the delete is cancelled.

Alternatively, the embodiment shown in FIG. 1a may be modified by replacing the program in the program memory 88 with one that displays OSD text. This modified program also redefines the arrow keys 40, 52, that scrolled through current images in the display mode before the program stored in program memory 88 was changed. The redefined arrow keys 40b, 52b, select options after one of the other control keys 42-50 is pressed in this OSD alternative embodiment. When the delete key 42 is pressed in the altered OSD embodiment, OSD delete options text appears on the monitor 32: “Delete image? <Yes or No>”. If the operator presses the “Yes” left arrow key 40b, the current image displayed on the video screen 32 is deleted from the working memory 86, making the previous current image in the stored image sequence the new current image 110. If the operator presses the “No” right arrow key 52b in response to the OSD image delete text: “Delete image? <Yes or No>” then the OSD remainder delete text appears on the monitor 32: “Delete to end? <Yes or No>”. If the operator selects the “Yes” arrow key 5240b OSD the current image and all images following it are deleted, making the stored image that precedes the deleted current image in the stored image sequence the new current image. Alternatively, if the operator pressed the “No” 102a right arrow key 52b, or presses any other key that is not the left arrow key 40b, the delete key 42 or the capture/confirm key 46b in response to the OSD remainder delete text “Delete to end? <Yes or No>” then the delete is cancelled.

However, if an operator presses the capture/confirm key 46b or the delete key 42a instead of one of the arrow keys in response to an OSD delete options text, the delete key 42 and capture/confirm key 46b operate as they do in the basic embodiments described above, to preserve consistency in the user interface. Similarly, if another key 44, 48-50, that is not the delete key, the capture/confirm key 46b or one of the arrow keys is pressed, then the delete is cancelled, as explained above.

The SD/MMC card slot 62 in FIG. 1a permits pre-recorded sound effects to be added to an animation sequence, and permits the operator to use the microphone 54 to record and archive sound effects and voice-overs or dialog for future use. Alternatively, pre-recorded sound effects can be selected by the operator from pre-recorded sound effects stored on a ROM chip 84 (not shown) 84 located under the worktable 12. Also, in the presently preferred embodiment of the invention shown in FIG. 1b, images are stored on a portable storage medium such as SD/MMC cards inserted in a slot 62a located in the camera's turret 20a. This image-storage medium extends the length of the movie that can be produced by the animation station 14a and provides individual archival storage media for multiple image sequences, thus also providing a storage medium that is not affected by power failures that may cause a loss of the images stored in working memory.

1. A workstation for producing a sequence of images, said station being adapted to store images in a memory and to provide a temporal sequence of stored images to a display screen as a movie, said station comprising:
a worktable having a positioning arm attached to said worktable;
a camera adapted to provide an image signal to the display screen, said camera being adapted to be attached to said positioning arm so that said image signal provides an image on the display screen that shows an object located on said worktable;
a first key adapted to selectably provide a first mode wherein said image signal from said camera is provided to the display screen and a second mode wherein a current image is provided to the display screen from an image stored in the memory;
a second key adapted to change said current image provided to the display screen by an image stored in the memory from a first current image provided to the display screen by said image stored in the memory to a second current image provided to the display screen by another image stored in the memory; and
a third key adapted to delete from the memory said image stored in the memory that provides said current image to the display screen.

2. The workstation of claim 1 wherein the station is in said first mode each time power is applied to the workstation.

3. The workstation of claim 1 further comprising a fourth key adapted to store an image captured from said image signal in memory in said first mode and adapted to enable deletion of said current image by said third key in said second mode.

4. The workstation of claim 3 wherein said third key is adapted to delete the temporal sequence from the memory when said third key is actuated twice before said fourth key is actuated.

5. The workstation of claim 1 wherein said positioning arm is angularly displaceable relative to said worktable and said camera is pivotably attached to said positioning arm.

6. The workstation of claim 1 wherein said camera is rotatably attached to said positioning arm, so that rotating said camera rotates said image provided by said image signal to the display screen.

7. The workstation of claim 1 further comprising a plurality of sound effects switches, each sound effects switch generating a respective sound effect when said switch is actuated.

8. The workstation of claim 1 further comprising sound recording means, said sound recording means being adapted to provide recorded sound for the stored temporal sequence.

9. An workstation for producing a sequence of images, said station being adapted to store images in a memory and to provide a temporal sequence of stored images to a video screen, as a movie, said station comprising:
a worktable having a positioning arm attached to said worktable;
a video camera adapted to provide an image signal to the video screen, said video camera being adapted to be attached to said positioning arm so that said image signal provides an image on the video screen that shows an object located on said worktable;
a first key adapted to selectably provide a first mode wherein said image signal from said camera is provided to the video screen and a second mode wherein a current image is provided to the video screen from an image stored in the memory;
a second key adapted to change said current image provided to the video screen by an image stored in the memory from a first current image provided to the video screen by said image stored in the memory to a second current image provided to the video screen by another image stored in the memory;
a third key adapted to delete from the memory said image stored in the memory that provides said current image to the video screen in said second mode;
a fourth key adapted to store an image captured from said image signal in memory in said first mode and adapted to enable deletion of said current image by said third key in said second mode; and
a fifth key adapted to display the temporal sequence of the images stored in the memory on the video screen as a movie.

10. The workstation of claim 8 wherein actuating said fifth key during said display of said temporal sequence of stored images as a movie is adapted to pause said movie display at a current image.

11. The workstation of claim 8 wherein said second key is adapted to select options displayed on the video screen after a key is pressed.

12. A method of producing images displayable from memory in a temporal sequence as a movie on a display screen using a workstation having a worktable attached to a camera, said method comprising the steps of:
locating an object on the worktable;
positioning the camera so that an image signal produced by the camera is adapted to provide an image on the display screen that shows the object;
actuating a first key to selectably alternate between a first mode wherein the image signal from the camera is provided to the display screen and a second mode wherein a current image is provided to the display screen from an image stored in the memory;
actuating a second key to change said current image provided to the display screen from an image stored in the memory from a first current image provided to the display screen from said image stored in the memory to a second current image provided to the display screen from another image stored in the memory; and
actuating a third key to delete from the memory the image stored in the memory that provides the current image to the display screen.

13. The method of claim 12 further comprising the step of applying power to the workstation, the workstation being in the first mode each time power is applied to the workstation.

14. The method of claim 12 further comprising the step of actuating a fourth key, the fourth key storing an image captured from the image signal in memory if the workstation is in the first mode and the fourth key enabling deletion of the current image by the third key if the workstation is in the second mode.

15. The method of claim 14 further comprising the step of actuating said third key a second time before said fourth key is actuated to delete the temporal sequence from the memory.

16. The method of claim 15, further comprising the step of:
actuating the fourth key again in the first mode to capture a subsequent image from the image signal and stores the subsequent image in memory as the current image.

17. The method of claim 12 wherein the positioning step comprises the steps of angularly displacing a positioning arm attached to the worktable and pivoting the camera on the arm.

18. The method of claim 12, further comprising the step of:
actuating a fifth key to display the temporal sequence of the images stored in the memory on the video screen as a movie.

19. The method of claim 18, further comprising the step of:
actuating said fifth key during said display of said temporal sequence of stored images as a movie to pause said movie display at a current image.

20. The method of claim 12 wherein options are displayed on the screen after a key is actuated and actuating the second key selects one of the options displayed on the video screen.
